(19) United States
(12) Patent Application Publication
(10) Pub. No.: US 2015/0199811 A1
(43) Pub. Date: Jul. 16, 2015

(54) METHODS AND SYSTEMS FOR PSYCHOPHYSICAL ASSESSMENT OF NUMBER-SENSE ACUITY

(71) Applicant: The Johns Hopkins University, Baltimore, MD (US)

(72) Inventor: Justin P. Halberda, Baltimore, MD (US)

(21) Appl. No.: 14/467,261

(22) Filed: Aug. 25, 2014

Related U.S. Application Data
(63) Continuation of application No. 12/976,806, filed on Dec. 22, 2010, now abandoned.
(60) Provisional application No. 61/288,974, filed on Dec. 22, 2009.

(51) Int. Cl. G06T 7/00; G06F 17/30

(52) U.S. Cl. CPC G06T 7/0012; G06F 17/3028

(57) ABSTRACT

Featured are methods and systems for psychophysical assessment of number-sense acuity. Such methods include determining at least a display time based on participant related information (e.g., age) and selecting images for viewing by the participant based on the participant related information, the selected images having a complexity appropriate for the participant. Such methods further include displaying each selected image to the participant for the determined display time, the participant providing a reply to an assessment question after viewing each selected image, and determining a parameter representative of the psychophysical assessment of number-sense acuity based on each reply by the participant.

This application is a continuation of U.S. application Ser. No. 12/976,806, filed Dec. 22, 2010, pending, which claims the benefit of U.S. Provisional Application Ser. No. 61/288,974 filed Dec. 22, 2009, the teachings of which are incorporated herein by reference.

### STATEMENT REGARDING FEDERALLY-SPONSORED RESEARCH

The present invention was supported by grants from the National Institute of Health, grant number NIH RO1-HD057258 and the National Science Foundation, grant number NSF EAGER DRL-0937675. The U.S. Government may have certain rights to the present invention.

### FIELD OF INVENTION

The present invention generally relates to psychophysical assessment of number-sense acuity, more particularly to psychophysical assessment of number-sense acuity and yet more particularly to methods and systems for psychophysical assessment of number-sense acuity.

### BACKGROUND OF THE INVENTION

The Approximate Number System (ANS) is a cognitive resource present in infants, non-human primates, and other animals and it is available without training from as early as four months of age in human infants. All individuals have an Approximate Number System (ANS) that is responsible for generating our intuitive “gut” sense of a number. It is the ANS that allows us, with a brief glance, to estimate e.g., the number of students in a classroom or the number of apples on a tree.

The ANS represents a number approximately with some amount of “noise” around each estimate (e.g., “around 25”), and different individuals have different levels of precision in these underlying representations. Individual differences in ANS precision have been measured and been shown to correlate with a person's success or failure in school mathematics. The precision of the ANS for each person increases throughout the school age years and may decline in the elderly.

It thus would be desirable to provide a methods and systems, e.g., computer systems, for assessment of number-sense acuity. It would be particularly desirable to provide such methods and systems for psychophysical assessment of number-sense acuity. Such methods and systems for psychophysical assessment of number-sense acuity preferably would not require participants in such assessments to be highly skilled in order to use such methods and systems.

### SUMMARY OF THE INVENTION

In its broadest aspects, the present invention features methods and systems for psychophysical assessment of number-sense acuity. Such methods include determining at least a display time based on participant related information (e.g., age) and selecting images for viewing by the participant based on the participant related information, where the selected images have a complexity appropriate for the participant. Such methods further include displaying each selected image to the participant for the determined display time, the participant providing a reply to an assessment question after viewing each selected image, and determining a parameter representative of the psychophysical assessment of number-sense acuity based on each reply by the participant. In further embodiments, such methods can be performed on a computer or the images being selected and displayed are contained on a physical medium having thereon indicia representative of a given image. In the later case, the medium carrying images are physically viewed by the participant during said displaying (e.g., flash cards such as used in a game format).

In another aspect of the present invention, there is featured methods for psychophysical assessment of number-sense acuity that are performed on a microprocessor. Such methods include determining at least a display time from a database including a plurality of possible display times, based on participant related information and selecting images from another database including a plurality of plural images based on the participant related information and displaying each selected image to the participant for the determined display time. In particular embodiments, the selected images have a complexity appropriate for the participant. Such methods further include having the participant providing a reply to an assessment question after viewing each selected image and determining a parameter representative of the psychophysical assessment of number-sense acuity based on each reply by the participant. In embodiments of the present invention, such methods include inputting at least age of the participant as the participant related information.

In embodiments of such methods, such selecting includes selecting N images from the database that have a complexity appropriate for the participant, where N is greater than or equal to two (N≧2). Also, such displaying includes displaying each of the N images to the participant for the determined display time and such determining a parameter includes determining a parameter for each of the N images.

In further embodiments, such selecting includes selecting X sets of N images from the database that have a complexity appropriate for the participant and based on the results, where X is greater than or equal to two (X≧2) and such displaying includes displaying each of the N images for each of the X sets to the participant for the determined display time and such determining a parameter includes determining a parameter for each of the X sets of N images.

In yet further embodiments, such selecting further includes selecting each next set (successor set) of N images after determining a complexity for the images based on the determined parameter(s) of the set of images previously displayed. Also, such displaying further includes determining another display time based on the determined parameter(s) for the set of images previously displayed before displaying each successor set of N images and displaying the N images of a given successor set of N images at the determined display times.

In yet further embodiments, such displaying further includes determining a successor display time based on the determined parameter(s) of the set of images previously displayed before displaying each successor set of N images and displaying the N images of a given successor set of N images at the determined successor display time.

In yet further embodiments, such determining includes determining at least a display time from a database including a plurality of possible display times, based on the participant's age; and such selecting includes selecting images from another database including a plurality of plural images based on an image complexity appropriate for the participant's age.

In yet further embodiments, such methods include providing a processing unit including an application program or a software program including code segments, instructions and criteria for carrying out any aspects or embodiments of the methodologies described herein.

According to another aspect of the present invention there is featured a system for psychophysical assessment of number-sense acuity, such a system including a computer system having a processing unit and a software program for execution on the processing unit. Such a software program includes code segments, instructions and criteria for carrying out any aspects or embodiments of the methodologies described herein.

According to yet another aspect of the present invention there is featured a system for psychophysical assessment of number-sense acuity, such a system including a computer system having a processing unit and a software program for execution on the processing unit. Such a software program includes code segments, instructions and criteria for determining at least a display time from a database including a plurality of possible display times, based on participant related information, selecting images from another database including a plurality of plural images based on the participant related information, the selected images having a complexity appropriate for the participant and displaying each selected image to the participant for the determined display time.

Such a software program also includes code segments, instructions and criteria for allowing the participant to provide a reply to an assessment question (e.g., generated by the software program) after viewing each selected image, and determining a parameter representative of the psychophysical assessment of number-sense acuity based on each reply by the participant. In more particular embodiments of the present invention, such software includes code segments, instructions and criteria for inputting at least age of the participant as the participant related information.

In embodiments of the present invention, the code segments, instructions and criteria for such selecting includes selecting N images from the database that have a complexity appropriate for the participant, where N is greater than or equal to two (N≧2). Also, the code segments, instructions and criteria for such displaying includes displaying each of the N images to the participant for the determined display time and the code segments, instructions and criteria for such determining a parameter includes determining a parameter for each of the N images.

In further embodiments, the code segments, instructions and criteria for such selecting includes selecting X sets of N images from the database that have a complexity appropriate for the participant and based on the results, where X is greater than or equal to two (X≧2). Also, the code segments, instructions and criteria for such displaying includes displaying each of the N images for each of the X sets to the participant for the determined display time; and the code segments, instructions and criteria for such determining a parameter includes determining a parameter for each of the X sets of N images.

In yet further embodiments, the code segments, instructions and criteria for such selecting further includes, selecting each next set (successor set) of N images after determining a complexity for the images based on the determined parameter(s) of the set of images previously displayed.

In yet further embodiments, the code segments, instructions and criteria for such displaying further includes, determining another display time based on the determined parameter(s) of the set of images previously displayed before displaying each successor set of N images and displaying the N images of a given successor set of N images at the determined display times.

In yet further embodiments, the code segments, instructions and criteria for such displaying further includes determining a successor display time based on the determined parameter(s) of the set of images previously displayed before displaying each successor set of N images and displaying the N images of a given successor set of N images at the determined successor display time.

According to yet further aspects of the present invention, there is featured a computer readable medium on which is stored an applications program for execution on a computer, wherein said applications program includes code segments, instructions and criteria for carrying out any aspects or embodiments of the methodologies described herein. In father embodiments, the computer readable medium is any of a number of mediums known to those skilled in the art which are fixed or non-transitory.

Other aspects and embodiments of the invention are discussed below.

### DEFINITIONS

The instant invention is most clearly understood with reference to the following definitions:

As used in the specification and claims, the singular form “a”, “an” and “the” include plural references unless the context clearly dictates otherwise.

As used herein, the term “comprising” or “including” is intended to mean that the compositions, methods, devices, apparatuses and systems include the recited elements, but do not exclude other elements. “Consisting essentially of”, when used to define compositions, devices, apparatuses, systems, and methods, shall mean excluding other elements of any essential significance to the combination. Embodiments defined by each of these transition terms are within the scope of this invention.

A computer readable medium shall be understood to mean any article of manufacture that contains data and/or digital information that can be read by a computer or a carrier wave signal carrying data that can be read by a computer. Such computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on a carrier wave signal received through a network, wireless network or modem, including radio-frequency signals and infrared signals. In more particular aspects, such a computer readable medium is fixed or non-transitory.

USP shall be understood to mean U.S. patent Number, namely a U.S. patent granted by the U.S. Patent and Trademark Office.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is a block diagram of an exemplary computer system on which the methodology of the present invention can be executed or performed.

FIG. 2 is a is a schematic block diagram of an exemplary network on which the methodology of the present invention can be performed.

FIGS. 3A-C include a high level flow diagram illustrating the methodology of the present invention.

FIG. 4 is a graphical view of activation versus mental number line.

FIG. 5 is a graphical view of an exemplary output graph of percent correct versus ratio from a single run from one participant.

### DESCRIPTION OF THE PREFERRED EMBODIMENT

The Psychophysical Assessment of Number-sense Acuity (PANA) is a dynamic assessment tool that is implemented as software or as a card-based board game designed to measure the precision of an individual's underlying approximate number representations. The Approximate Number System (ANS) is a cognitive resource present in infants, non-human primates, and other animals and it is available without training from as early as four months of age in human infants.

All individuals have an Approximate Number System (ANS) that is responsible for generating our intuitive “gut” sense of a number. It is the ANS that allows us, with a brief glance, to estimate e.g., the number of students in a classroom or the number of apples on a tree. The ANS represents a number approximately with some amount of “noise” around each estimate (e.g., “around 25”), and different individuals have different levels of precision in these underlying representations.

The PANA assessment guides a participant of any age through a task that involves watching brief flashes of sets of items, either on a computer screen or on cards, and, on each trial, the participant attempts to determine which of the two sets is the more numerous. A single assessment can take as little as 5 minutes and is designed as an engaging video or card game. In further embodiments, during an assessment implemented on a computer, the software dynamically adjusts the display time and/or the ratio between the two sets that are shown on each trial, based on the performance of the participant, in order to determine with precision the acuity of the participant's underlying ANS representations. As described further herein, such dynamic adjustment can be utilized to adjust the complexity of the images being displayed (upwardly or downwardly) and/or adjusting the display times (increasing or decreasing).

The assessment is designed for use with children and adults from the ages of three years to the elderly, and it is appropriate for both normal and learning disabled individuals. The basic principles behind the assessment and its implementation allow core aspects of the PANA assessment to be included, with adjustment, in other software, other programs, and non-computer based applications thereby connecting with a diverse set of possible applications (e.g., toys, self-improvement across the lifespan, school preparedness, math curricula).

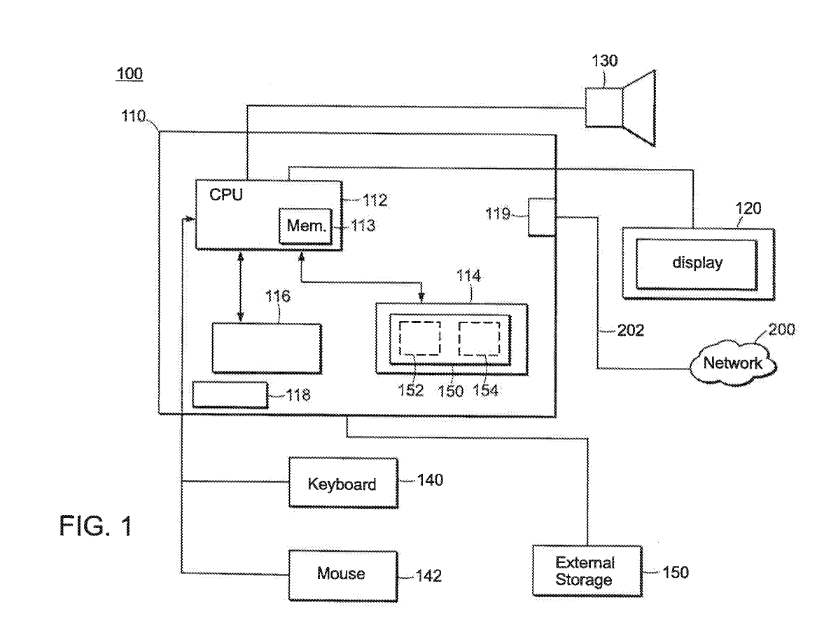

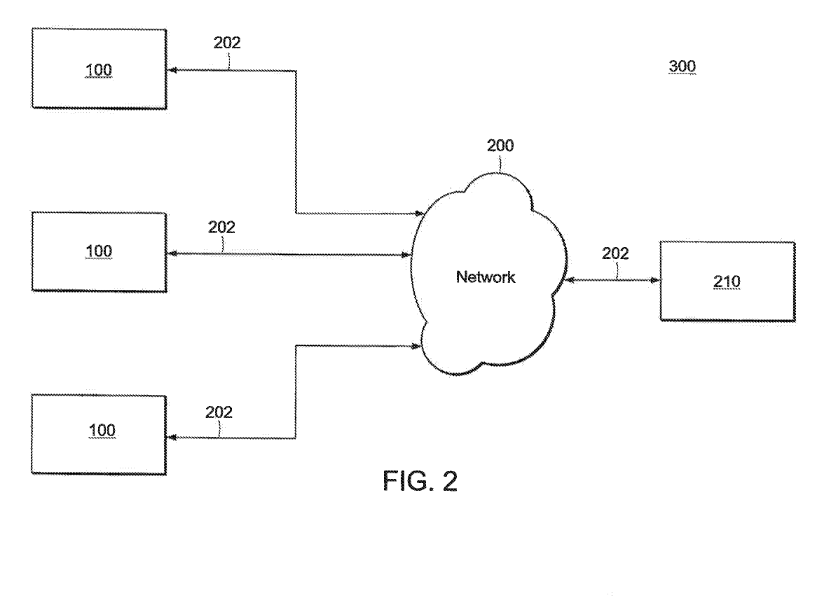

Referring now to the various figures of the drawing wherein like reference characters refer to like parts, a block diagram of an exemplary computer system 100 on which the methodology of the present invention can be performed, is shown in FIG. 1. Such a computer system 100 includes a computer 110, a display 120, a speaker 130 and input devices 140, 142. In further embodiments, such a computer is operably coupled to an external storage device 150.

The display 120 is any of a number of devices known to those skilled in the art for displaying images responsive to outputs signals from the computer 110. Such devices include but are not limited to cathode ray tubes (CRT), liquid crystal displays (LCDS), plasma screens and the like. Although a simplified block diagram is illustrated such illustration shall not be construed as limiting the present invention to the illustrated embodiment. It should be recognized that the signals being outputted from the computer can originate from any of a number of devices including PCI or AGP video boards or cards mounted with the housing of the computer 110 that are operably coupled to the microprocessor 112 and the display 120.

The speaker 130 is any of a number of auditory signal generating devices known to those skilled in the art that generate an auditory signal or auditory output responsive to outputs signals from the computer 110. Although a simplified block diagram is illustrated such illustration shall not be construed as limiting the present invention to the illustrated embodiment. It should be recognized that the signals being outputted from the computer 110 to the speaker 130 can originate from any of a number of devices including PCI sound boards or cards located within the computer that are operably coupled to the microprocessor 112 and the speaker 130. Also, and although an external speaker 130 is illustrated, this shall not be construed as limiting the invention as the speaker 130 can be disposed internally within the housing or case of the computer 110 as well as being a speaker or a system of speakers external to the computer.

The input devices 140, 142 are any of a number of devices known to those skilled in the art which can be used to provide input signals to the computer for control of applications programs and other programs such as the operating system being executed within the computer. In illustrative embodiments, one input device 140 is a keyboard 140 which a participant or others can provide inputs to the central processing unit 112 or microprocessor as described herein. The other input device 142 is a mouse, a switch, a slide, a track ball, a glide point or a joystick, which devices allow a user such as the participant, researcher or technician to input control signals other than by means of a keyboard. The keyboard comprises any of a number of keyboards known to those skilled in the art, wherein the control signals or commands for implementing the methodology and the applications program embodying such methodology are implemented in the form of discrete commands via the keyboard.

The computer 110 typically includes a central processing unit 112 including one or more micro-processors such as those manufactured by Intel or AMD, Motorola or the like, random access memory (RAM) 113, mechanisms and structures for performing I/O operations 118, a network connection device 119, storage medium such as a magnetic hard disk drive(s) 114 or other drives (fixed or removable) for storage of data, operating systems or the applications or software programs of the present invention, and a device 116 for reading from and/or writing to a removable computer readable medium such as for example an optical disk reader capable of reading CDROM, DVD or optical disks and readers of other types of nonvolatile memory.

Such non-volatile computer readable removable medium read, is any of a number of mediums known to those skilled in the art where data remains stored in the medium after power is withdrawn and where data can be removed or erased there from without requiring the replacement of the medium. For example, such non-volatile computer readable removable medium read comprises non-volatile memory such as flash memory, nonvolatile random access memory (NVRAM) or spindle non-volatile memory as is known to those skilled in the art.

The hard disk drive(s) 114 is/are provided for purposes of booting and storing the operating system, other applications or systems that are to be executed on the computer, paging and swapping between the hard disk and the RAM and the like. Also included or stored on the hard drive, is an applications program or software program 150 of the present invention, including a portion 152 having the programming instructions and a data portion 154 containing the text, auditory and visual informational data associated therewith.

The external storage device 150 is any of a number or devices or apparatuses as is known to those skilled in the art that can be removably connected to the computer in any of a number of ways as is known to those skilled in the art. As is known to those skilled in the art, the external storage device can be operably coupled to the circuitry involved with the transmission of data to from the hard drive 114 or it can be coupled through an I/O device to the computer such as is done for devices that are described as USB external hard drives.

According to another embodiment of the present invention, the applications program of the present invention that is stored on the hard drive, includes a portion 152 including the programming instructions and a data portion 154 containing the text, auditory and visual informational data associated therewith. In use, the participant accesses the applications program for a sequence(s) of trials and the data associated therewith directly from the hard drive 114 for example, by entering appropriate commands via the keyboard or by other appropriate action of the input device (e.g., positioning the cursor over an icon on the desktop and clicking a mouse button).

In further aspects, there is shown in FIG. 2 a schematic block diagram of an exemplary network based computer system 300 on which the methodology of the present invention can be performed such a system includes a network infrastructure 200. The network infrastructure 200 can be any of a number of networks as are presently know in the art or hereinafter developed. Such networks include local area networks (LAN), wide area networks (WAN), intranets, Internet and the like. Such a network based computer system 200 includes a server 210 and a network infrastructure 300 that operably couples a plurality or more of client computer systems 100 to the server 210. The client computer systems 100 are typically configured like the computer system of FIG. 1 except that in use the participant would access the applications program and related data of the present invention for a given usage from the server 210 and upload such information temporarily onto the client computer system.

The server 210 is any of a number of servers known to those skilled in the art that are intended to be operably connected to a network so as to operably link a plurality or more of client computers via the network to the server. Such a server 210 typically includes a central processing unit including one or more microprocessors such as those manufactured by Intel or AMD, Motorola or the like, random access memory (RAM), mechanisms and structures for performing I/O operations, a storage medium such as a magnetic hard disk drive(s), and an operating system for execution on the central processing unit. The hard disk drive of the server typically is not used for storing data and the like utilized by client applications being executed on the client computers. Rather the hard disk drive(s) of the server 210 is/are typically provided for purposes of booting and storing the operating system, other applications or systems that are to be executed on the server, paging and swapping between the hard disk and the RAM. However, it is within the scope of the present invention for results and outputs and other information relating to the execution of the application program of the present invention, to be uploaded to the server so that a researcher or technician can access such information for further analysis.

Data and the like being used in connection with the execution of client applications, such as the applications program of the present invention and the information and/or data related thereto, on client computers is stored in the server 210 or an external storage device operably coupled thereto, using any of a number of techniques and related devices or cabling known to those skilled in the art. In an illustrative embodiment, such an interconnection is implemented using a small computer systems interface (SCSI) technique(s) or via a fiber optic cable or other high-speed type of interconnection.

In an illustrative, exemplary embodiment, such an external storage device includes a disk assembly typically made up of one or more hard disks that are configured and arranged so the external storage medium functionally appears to the server 210 as a single hard disk. Such an external storage medium is further configured and arranged to implement any of a number of storage schemes such as mirroring data on a duplicate disk (RAID level 1) or providing a mechanism by which data on one disk, which disk has become lost or inaccessible, can be reconstructed from the other disks comprising the storage medium (RAID level 5). Although reference is made to a disk assembly and hard disks, this is for illustration and shall not be construed as being a limitation on the particular form of the devices or mechanism that makes up an external storage device or the medium comprising such a device.

In addition, each of the client computers 100 includes one or more network communication ports or devices 119 that are operably connected to the microprocessor 112 and which are configured and arranged for the transfer of the data and program instructions between and amongst the client computer and the server 210 using any of a number of techniques known to those skilled in the art including non-wireless techniques (e.g., using hard lines 202) or wireless techniques known to those skilled in the art. Such non-wireless techniques include for example any of a number of network infrastructures 300 known to those skilled in the art such as Ethernet, token ring, FDDI, ATM, Sonet, X.25 and Broadband.

In the case of wireless techniques, the network communication devices of the client computers are configured so as to include a transceiver as is known to those skilled in the art for wireless network transmission systems. An exemplary wireless network technique includes those systems embodying a transceiver or transmitter complying with IEEE-802.11, sometimes referred to as a Bluetooth chip. In each case, the transceiver operably coupled to the client computer is configured and arranged so as to establish a communications link between the client computer and a receiver or transceiver remote from the location of the client computer that is in turn operably coupled to the server 210. For example, with a client computer 100 having a IEEE-802.11b or 802.11g compliant transceiver, the corresponding remotely located transceiver/receiver would be located within about 100 meters or so of the location of the client computer device and operating at a frequency of about 2.4 GHz. The server 210 in turn could be coupled to the remotely located transceiver/receiver using non-wireless or wireless techniques.

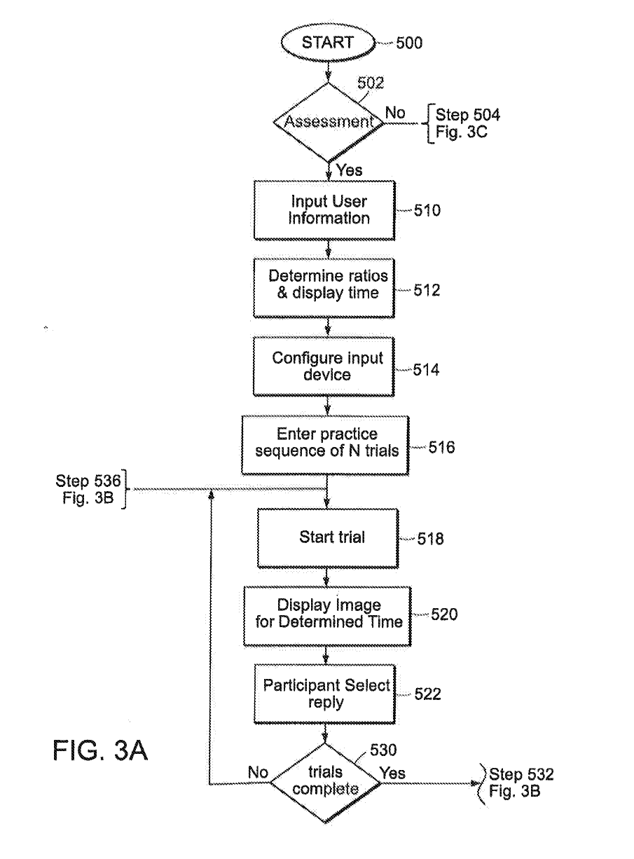

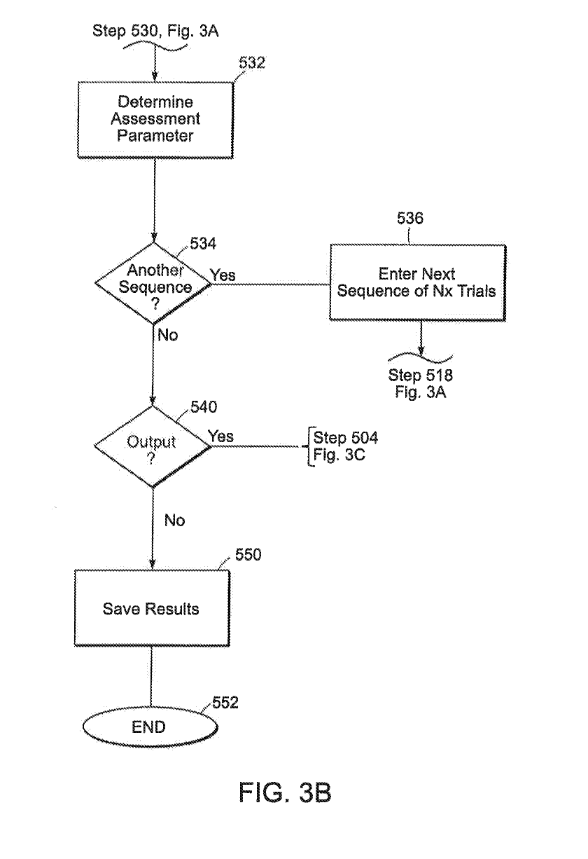

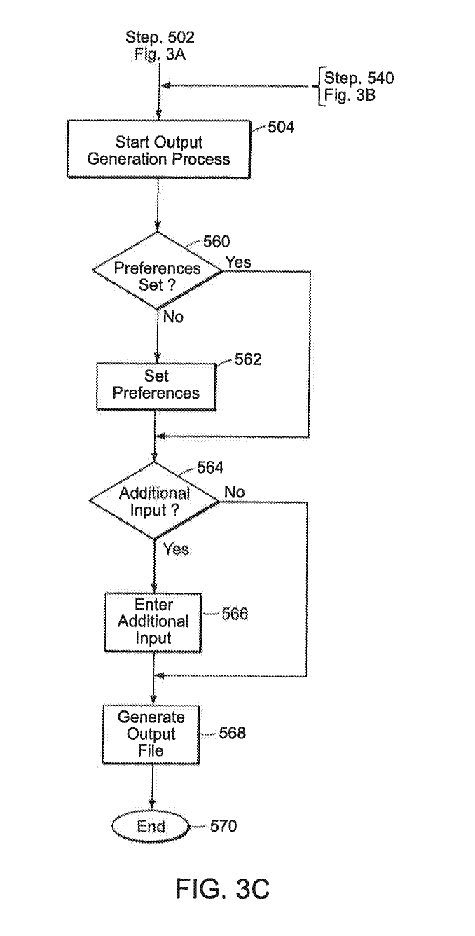

Referring now to FIGS. 3A-C there is shown a high level flow diagram illustrating the various methodologies for the psychophysical assessment of number-sense acuity (PANA) according to the present invention. The flow chart(s) herein as well as the following discussion illustrate the structure of the logic of the different methodologies/inventions, which can be embodied in computer program software for execution on a computer, digital processor or microprocessor or for storage on a computer storage medium. Those skilled in the art will appreciate that the flow charts illustrate the structures of the computer program code elements, including logic circuits on an integrated circuit, that function according to the present inventions. As such, the present inventions are practiced in its essential embodiments by a machine component that renders the program code elements in a form that instructs a digital processing apparatus (e.g., computer) to perform a sequence of function step(s) corresponding to those shown in the flow diagrams. Reference also should be made to FIGS. 1-2 and the discussion therefore, for features not otherwise shown in FIGS. 3A-C.

As indicated herein, the methodology of the present invention is implementable for execution on a computer 100 or implemented as a flash card game, where certain aspects of the methodology (e.g., calculations, adjustments and the like) requiring decision making or calculations would be implemented by a researcher, technician or educator. In the computer implemented methodology, the processes involved with selecting, displaying and determining if there is a need to adjust display times, ratios and/or display times is automatically carried out by the computer thereby advantageously reducing assessment time. Prior to implementation of the methodology on a computer, a participant or user (e.g., individual child, adult, researcher or educator) installs the PANA applications program on their computer 100 (e.g., desktop, laptop, netbook, powerbook, or the like) and thereafter, the participant or user (individual child, adult, researcher or educator) would start the applications program, Step 500. For example, the user the user would click on a single program icon.

After starting the process, the user would take the appropriate actions whereby it can be determined if the process is to continue with the assessment process or the generation of an output, Step 502. For example, when the user interface page is opened, there will be two options designated by buttons: “Run Participant” and “Generate Output”. The “Run Participant” button will navigate the user to the testing environment (YES, Step 502). If the “Generate Output” button is designated (NO, Step 502), the process proceeds to starting the output generation process, Step 504, which is discussed further below.

When the process navigates the user to the testing environment, the process continues with requesting input of information regarding the participant, Step 510. For example, within the testing environment, a JAVA window opens and prompts the user to enter identifying information for the participant. This could also occur before the participant arrives for researchers who maintain separate data entry and testing protocols. In exemplary embodiments, the information requested by the program includes the participant's name (e.g., First, Last) and the participant's date of birth (e.g., Month, Date, Year). A unique, untraceable identifier is generated by the program relating to the participant's name, the identifier is used in all data storage to maintain anonymity of the participants.

Also, after obtaining such information, the process continues with determining ratios and display times, Step 512. The participant's date of birth (e.g., Month, Date, Year) is used by the program to compute the participant's age at the time of testing in order to determine the ratios and display times that will be used for the participant. Such information also can be used to determine the complexity of the images to be displayed during the assessment process. These ratios and display times will be visible to the user in the output files. The applications program, more particularly a database associated therewith, will include default settings as a function of age in years for ages 3 years to adults. In particular embodiments, these settings are determined from predetermined data, such as the date from two cross-sectional studies which included a total of 160 participants (Halberda & Feigenson, 2008; Halberda, Mazzocco & Feigenson, 2008).

Thereafter and if not earlier done, the input devices are configured for the testing mode to avoid unintended inputs, Step 514. For example, the JAVA window will enter the testing mode such that participants sitting at the computer will see a large gray window that covers the entire screen. In addition, all keys on the keyboard 140 except for the response keys, and the mouse 142 will be disabled by the applications program so that only activity relevant to the program is possible by the participant. In more particular embodiments, the program would disable all but three response keys: ‘f’, ‘j’, ‘spacebar’ and the mouse so that only these response keys can be used by the participant, In further embodiments, a separate key sequence is provided so that the participant, researcher/educator can exit the program if needed. The gray screen or other colored screen will serve as the background for all activity during testing.

In yet further embodiments, the ‘f’ and ‘j’ keys are marked with a removable, reusable colored (e.g., yellow or blue) tape to highlight the mapping between the keys and the sets of dots flashed on each trial. This marking tape can be included with the disk or computer readable medium on which the applications program is stored.

Thereafter, the program enters the practice sequences, Step 516 and the participant starts the first trial of the sequence, Step 518. For example, the participant is prompted by the program to press the spacebar, such prompting also could be initiated by action of the researcher/educator who is operably coupled to the program as well. This initiates an introduction and practice sequence of trials that is adjusted to be appropriate as a function of the participant's age at the time of testing. In other words, the images being displayed have an appropriate complexity for the participant's age. In exemplary, illustrative embodiments, there is 5 levels of instructional complexity ranging from an entirely graphic environment for young children (age 3 years) to an entirely text-based instruction sequence for adults.

After pressing of the spacebar, the process continues with starting the trial, Step 518, displaying the images to the be viewed by the participant, Step 520, and the participant providing (e.g., inputting) a reply for each image displayed image, Step 522. In the case where the method is being implemented in a flash card or game environment, each card would contain the image to be viewed and the participant's reply would either be verbal or in writing. In addition, after the participant completes each trial the process determines if all trials of the sequence have been completed, Step 530. If all trials have not been competed for the given sequence (NO, Step 510), the process returns to Step 518 and Steps 518-530 are repeated.

In further exemplary embodiments, the instructions will guide the participant in the pressing of the relevant keys (‘f’ for ‘yellow set has more’, ‘j’ for ‘blue set has more’, and ‘spacebar’ for initiating a new trial. Following instruction in the task and key pressing, the process leads the participant through N practice trials, where N is an integer. In illustrative embodiments, N is 10, however, N is determined based on the age of the participant and on practical aspects such as how long attention can be maintained for such testing.

Preferably, the screen provides a prompt to the participant, for example, the participant sees a ‘get ready’ screen, providing a warning that the trial is to start. For example, for adults and older children this includes the words “Get Ready” and a “number of practice trials remaining” counter that counts down as each trial is completed. For younger children, the ‘get ready’ screen includes a cartoon character standing next to a graduated cylinder that gradually fills up as the participant completes more and more trials.

For each ‘get ready’ screen the participant will be instructed to press the ‘spacebar’ when they are ready to initiate a trial. In this way, the ‘get ready’ screens serves as a participant-controlled break between trials. PANA will measure numerical acuity, an enduring trait unique to each participant, and is not meant to be a test of stamina or will power. It has been found that children on average take 2-4 seconds between trials. When the ‘spacebar’ is pressed the ‘get ready’ screen disappears and, after a predetermined time delay (e.g., 250 ms), one of the selected images is displayed.

For example, an array of yellow and blue dots flashes on the screen for the specified amount of time that will be set by PANA as a function of the age of the participant. This array of blue and yellow dots is the test array. The predetermined time delay (e.g., the 250 ms delay) allows visual working memory to refresh before the test display appears and removes any ‘forward masking’ that would be caused by the ‘get ready’ screen.

As the participant watches the array of yellow and blue dots flash on the screen, their task is to try and determine which color has more dots, The use of yellow and blue ensures that colorblind individuals will also be able to perform this task as they will experience the yellow and blue as having clear luminance differences, where red and green would be indiscriminable. In pilot testing, participants naturally found that they relied on their first impression (this impression is in fact due to the Approximate Number System that PANA is meant to measure). Because the items are flashed quickly, counting or grouping strategies are not particularly effective.

In further embodiments, one half of the trials, randomly determined, will be Area Controlled trials in which there are an identical number of and yellow pixels on the screen (though the number of dots in these two sets differs). These trials ensure that participants' answers are based on the number of items rather than on total surface area. The other half of the trials will be Dot-Size Controlled in which the average dot size is identical for the blue and yellow sets. These trials will allow PANA to calculate the extent to which a participant relies on surface area to reach a numerical decision.

In yet further embodiments, on the first 3 of the 10 practice trials, the process presents trials from the easiest ratio, given the participant's age, and provides feedback to the participant following their button press. This feedback will come in the form of a friendly voice (announced over the speaker 130) and a graphic shown on the display 120. In yet further embodiments, if the participant chooses correctly on a practice trial the voice says one of 3 positive phrases, “that's right”, “terrific”, “hurray”. In yet further embodiments, this voice is accompanied by a short clip of a cartoon green check mark bouncing up and down, after which the screen will return to the ‘get ready’ screen. If the participant chooses incorrectly during these first 3 practice trials no sound and no graphic are displayed.

In yet further embodiments, the process reminds the participant that they should press the key matching the color that has more dots, even if the dots are different sizes. The process will then allow the participant to try again and repeat the trial. If the participant does not press correctly during this next attempt, PANA moves on to the next practice trial. In pilot testing it was found that all participants, even 3 year olds, began pressing the correct keys within the first 3 trials. This training may need to be modified and extended for very young children with learning difficulties. Before practice trial 4, the participant is advised both auditorially and in text, “Now you can try some on your own.” At this point, the process ceases to give feedback and after each trial will move directly to the ‘get ready’ screen.

If all trials are completed (YES, Step 530, the process continues with determining an assessment parameter that is representative of the psychophysical assessment of number-sense acuity for the participant. In more particular embodiments, the program determines an estimate for the participant's Weber fraction (w), computed via the psychophysics model, and the percent confidence in this estimate (calculated as a function of the size of the 95% confidence interval for the estimate).

After such a determination, the process continues with determining if another sequence of trials should be undertaken by the participant, Step 534. If it is determined that another sequence of trials should be done (YES, Step 534) then the next sequence of trials is entered. In particular embodiments, after practice trial number N (e.g., 10), the process displays a short graphic of a cartoon character (younger children) or text (older children and adults) and the female voice will say, “let's do some more”, after which the screen returns to the ‘get ready’ screen. Note, that everything in the processes operations can be understood with the sound entirely off making the software suitable for both hearing and hearing impaired (e.g., deaf) participants. Thereafter, the process continues with Step 536 and thereafter returns to Step 518 and the processes described in Steps 518-522 and 530-536 are repeated until it is determined that there are no more trial sequences (NO, Step 534). In exemplary embodiments, the process is arranged so that an additional forty trials are conducted.

If there are no more trial sequences, the process continues with determining if the participant wants to generate an output of the just completed assessment process, Step 540. The generation of an output is discussed below. If an output is not desired (NO, Step 540, the process continues with saving the results and other information (e.g., to a database containing such information), Step 550 and ending the process, Step 552. In further embodiments, once the process is completed a ‘thank you’ is displayed on the screen and the participant is advised that they are done or that testing is complete. Such an assessment or testing when conducted using a computer is expected to takes less than 10 minutes and is expected to be engaging and fun across all ages tested (3 years to adults). In yet further embodiments, once testing is completed, the participant or researcher/educator presses a standard key sequence to exit the testing environment.

As indicated above, if it is not desired to enter the testing environment (NO, step 502), the process continues with starting the output generation process, Step 504. This provides a mechanism by which a researcher/educator can refer to testing results and related information and obtain outputs of same outside of the testing environment. As also indicated above, if a participant wants to generate an output file (YES, Step 540), the process continues with starting the output generation process, Step 504.

As described in more detail below, after entering the output generation process, the process continues with determining if the preferences are set Step 560, and if preferences are not set (NO, Step 562), setting or inputting such preferences, Step 562. After setting the preferences (Step 562) or if the preferences were already set (YES, Step 560), the process continues with determining if additional input is desired Step 564, and if so (YES, Step 564), entering or inputting such additional information/input, Step 566. After entering or inputting the additional information (Step 566) or if not such additional input is desired (NO, Step 564), the process continues with generating an output file, Step 568 and after generating the output file the process ends, Step 570.

In further embodiments, response to the key sequence for generating an output file, the process also can cause the screen to show the estimate for the participant's Weber fraction (w), computed via the psychophysics model, and the percent confidence in this estimate (calculated as a function of the size of the 95% confidence interval for the estimate). If the Weber fraction (w) estimate and confidence is all the information the researcher/educator requires, they are free to note this information for their records and press an “Exit PANA” button (i.e., exit program button) which will exit the program (this information also will be automatically saved in the record file for each run of PANA, so that such information can be retrieved at any later time).

The other choice on this screen is an “Additional Output” button. If the researcher/educator presses the “Additional Output” button, the process continues with displaying a data entry page where the researcher/educator has the option of entering additional identifying information they want to appear on the Output files. These will include Gender and known Math Learning Disability status as well as any additional entries suggested by users. After entering any additional data on the data entry window the researcher/educator will press one of two buttons: “Save and Take Me Directly To The Output File” or “Save and View Output Later”. In either case (and if the user presses the “Exit PANA” button), the process searches the stored files for all previous runs of the program in the current folder to check whether an assessment(s) for the current participant has been run before and if so when and how many times. The result of this search will be that the process can continue with entering a column in the output file noting how many previous runs this participant has made through the assessment process. This will allow for an analysis of any practice effects.

The Output file is generated according to the preferences set by the user. As indicated herein, the process/program will store the data for each run of the program and so these preferences can be changed at any time for future or past data files. If these preferences have not been set when the researcher/educator asks to see an Output file, the process prompts the researcher/educator to set their preferences for Output files and then open the Preferences page. Alternatively, the Preferences page can be opened via the main page by clicking on the “Generate Output” button.

In illustrative embodiments, on the Preferences page, the researcher/educator will be given an array of check boxes to check or uncheck in order to turn on desired output information. As a default, participant's unique identifying code, DOB, and age at time of testing is turned on. In addition to this identifying information, the check box for the Weber fraction estimate (w) also is turned on as a default. If only this information is desired, the researcher/educator can click one of two buttons on the preferences page: “Show Output for One Participant” or “Show Output for All Participants”. The “One Participant” button will open a drop down menu where the unique identifiers for each run of the assessment process the current folder will be displayed and the researcher/educator will choose the file they would like to view. The “All Participants” button will open a large file that includes the requested information for every run of an assessment process/program in the current folder (PANA will include a current folder for data being analyzed and viewed as well as archive folders for storing information from past, non-active, runs of PANA).

In further embodiments, on the Preferences page, additional check boxes that the researcher/educator may wish to turn on include: 95% confidence interval in estimate of w, Overall percent correct, Output separated by Area-Controlled and Dot-Size Controlled trials, Percent correct by ratio, Graph of raw data and modeled fit, R² for modeled fit, Display model equation, Area-Controlled Dot-Size Controlled difference score (an indicator of the extent to which a participant relies on area), Gender, and Math LD status. Output files will be generated as tab deliminated files and can be opened in any text program or data analysis program (e.g., SPSS, SAS, Excel).

### The Psychophysics Behind PANA

The testing environment of PANA or the assessment process is based on a simple numerical discrimination task. Similar tasks have been used throughout the psychophysics literature for decades and provide accurate estimates of individual acuity for dimensions such as numerical, luminance, size, and color discrimination. The new idea behind PANA is to create a unified assessment tool that combines dynamic controlling of display parameters, and algorithms that dynamically adjust to a user's performance and then models performance within a unified framework to create a user-friendly assessment of number sense acuity. No such program currently exists.

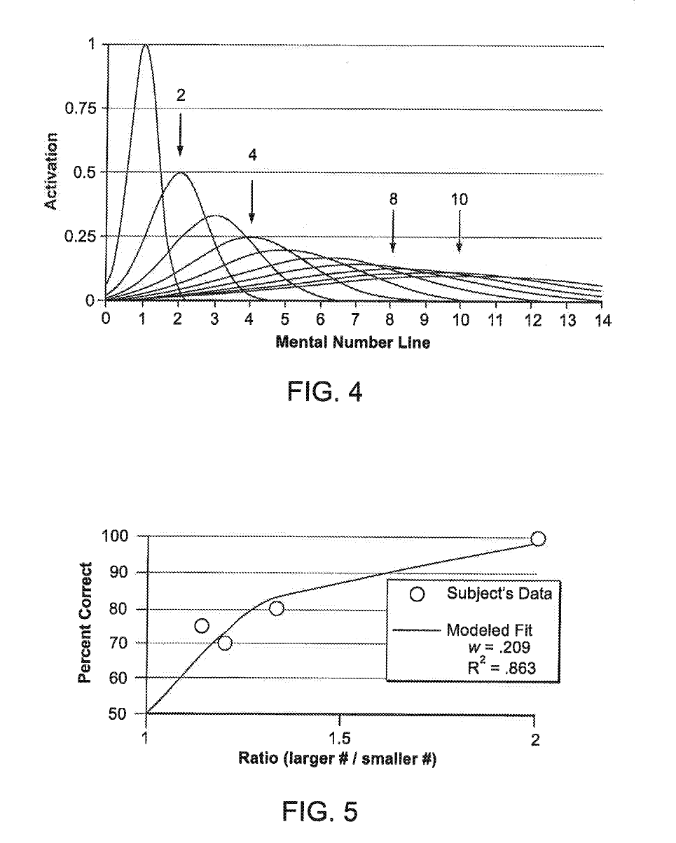

In modeling performance on tasks that engage the Approximate Number System, such as the numerical discrimination task of the present invention, one must first specify a model for the underlying approximate number representations for the “number sense”. It is generally agreed that numerosities are represented by distributions of activation on a mental “number line”. Neuropsychological research with human patients, single-cell recording in awake behaving animals, and brain imaging in normal human adults have localized these representations to the horizontal segment of the intraparietal sulcus. These representations are inherently noisy and do not represent number exactly or discretely. The mental number line is often modeled as having linearly increasing means and linearly increasing standard deviation. Such a representational format can be seen in FIG. 4 where each Gaussian curve representing a number within the Approximate Number System.

In this psychophysical treatment of the representations that underlie the number sense, the overlap between any two Gaussian representations is the area of confusability of the two numerosities, and their area of non-overlap is the area of successful discrimination. Numerosities 2, 4, 8, and 10 are highlighted in FIG. 4 for demonstration of this point. There is less overlap between the Gaussians for 2 and 4 than there is between 8 and 10. This is why the model is able to capture the ratio-dependent performance that characterizes numerical discrimination. While 2 from 4, and 8 from 10, result in the same numerical difference (i.e., 2) 8 and 10 overlap to a far greater extent in the Gaussian representations than 2 and 4 making it easier to distinguish 2 from 4 than 8 from 10.

The mental number line can also be conceived of as logarithmically organized with constant standard deviation. Either format yields the hallmark property of numerical discrimination: discrimination of two quantities is a function of their ratio, thus instantiating Weber's law. In our modeling we rely on the linear format, though either format would obtain the same result for a task as simple as numerical discrimination.

The PANA methodology and software embodying same, uses a psychophysical model that provides a psychologically plausible model of performance in numerical discrimination. Percent correct is modeled as a function of increasing ratio (larger set/smaller set, or n2/n1). The numerosity for the blue set and yellow set are represented as a Gaussian random variables (i.e., X2 & X1) with means n2 & n1 and standard deviations equal to the Weber fraction (w)*n. Subtracting the Gaussian for the smaller set from the larger returns a new Gaussian that has a mean of n2-n1 and a standard deviation of w√n1²+n2² (simply the difference of two Gaussian random variables). Percent correct is then equal to 1-error rate, where error rate is defined as the area under the tail of the resulting Gaussian curve computed as:

$$= \frac{1}{2} erfc ( \frac{{n}_{1} - {n}_{2}}{\sqrt{2} w \sqrt{{n}_{1}^{2} + {n}_{1}^{2}}} )$$

This equation fits percent correct for each ratio bin in the numerical discrimination task as a function of the Gaussian number representation for each set (i.e., yellow dots and blue dots) with a single free parameter, the Weber fraction (w). The Weber fraction (w) determines the predicted percent correct for any numerical comparison and predicts that the larger the ratio difference between the two numbers the higher the percent correct should be. This increase in percent correct is entirely determined by a participant's Weber fraction. An individual subject's Weber fraction (w) describes the standard deviations for the Gaussian representations of the Approximate Number System, thereby describing the amount of overlap between any two Gaussian representations, and thereby predicting percent correct for any numerical discrimination.

The issue for a user of PANA is simply that the model can parsimoniously (with one free parameter) determine an estimate that describes the numerical acuity for any participant. Using the methodology and software of the present invention, this occurs in an automated fashion behind the scenes of the program and without the researcher or educator requiring extensive training in psychophysics (though the information will be available as an option in the output for those who are interested).

Using this model, PANA will determine the best-fit value for the Weber fraction (w) by both Levenberg-Marquardt nonlinear least squares fit and Maximum Likelihood Estimation. These procedures return not only an estimate for to but also the 95% confidence interval for w and a % confidence in the estimate. This allows the user of PANA to decide when additional testing of an individual participant may be necessary. An example output graph from a single run from one participant is shown in FIG. 5 This graph includes the participant's raw data, the modeled fit, the estimate of the participant's Weber Fraction (w) and the R² value for the agreement between the model and the raw data, all of which will be options within PANA.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A method for psychophysical assessment of number-sense acuity, said method comprising the step(s) of:
determining at least a display time based on participant related information;
selecting images for viewing by the participant based on the participant related information, the selected images having a complexity appropriate for the participant;
displaying each selected image to the participant for the determined display time;
the participant providing a reply to an assessment question after viewing each selected image; and
determining a parameter representative of the psychophysical assessment of number-sense acuity based on each reply by the participant.

2. The method of claim 1, wherein said method is performed on a computer.

3. The method of claim 1, wherein the images being selected and displayed are contained on a physical medium having thereon indicia representative of a given image and wherein the medium carrying images are physically viewed by the participant during said displaying.

4. A method for psychophysical assessment of number-sense acuity that is performed on a microprocessor, said method comprising the step(s) of:
determining at least a display time from a database including a plurality of possible display times, based on participant related information;
selecting images from another database including a plurality of plural images based on the participant related information, the selected images having a complexity appropriate for the participant;
displaying each selected image to the participant for the determined display time;
the participant providing a reply to an assessment question after viewing each selected image; and
determining a parameter representative of the psychophysical assessment of number-sense acuity based on each reply by the participant.

5. The method of claim 4, wherein:
said selecting includes selecting N images from the database that have a complexity appropriate for the participant, where N is greater than or equal to two (2);
said displaying includes displaying each of the N images to the participant for the determined display time; and
said determining a parameter includes determining a parameter for each of the N images.

6. The method of claim 4, wherein:
said selecting includes selecting X sets of N images from the database that have a complexity appropriate for the participant and based on the results, where X is greater than or equal to two (X≧2);
said displaying includes displaying each of the N images for each of the X sets to the participant for the determined display time; and
said determining a parameter includes determining a parameter for each of the X sets of N images.

7. The method of claim 6, wherein said selecting further includes selecting each next set (successor set) of N images after determining a complexity for the images based on the determined parameter(s) of the set of images previously displayed.

8. The method of claim 7, wherein said displaying further includes determining another display time based on the determined parameter(s) of the set of images previously displayed before displaying for each successor set of N images and displaying the N images of a given successor set of N images at the determined display times.

9. The method of claim 6, wherein said displaying further includes determining a successor display time based on the determined parameter(s) of the set of images previously displayed before displaying each successor set of N images and displaying the N images of a given successor set of N images at the determined successor display time.

10. The method of claim 4, further comprising the step(s) of:
inputting at least age of the participant as the participant related information.

11. The method of claim 10, wherein:
said determining includes determining at least a display time from a database including a plurality of possible display times, based on the participant's age; and
said selecting includes selecting images from another database including a plurality of plural images based on an image complexity appropriate for the participant's age.

12. The method of claim 4, further comprising the step(s) of:
providing a processing unit.

13. A system for psychophysical assessment of number-sense acuity, said system comprising:
a computer system including a processing unit;
a software program for execution on the processing unit, said software program including code segments, instructions and criteria for carrying out the method of claim 4.

14. A system for psychophysical assessment of number-sense acuity, said system comprising:
a computer system including a processing unit;
a software program for execution on the processing unit, said software program including code segments, instructions and criteria for:
determining at least a display time from a database including a plurality of possible display times, based on participant related information;
selecting images from another database including a plurality of plural images based on the participant related information, the selected images having a complexity appropriate for the participant;
displaying each selected image to the participant for the determined display time;
the participant providing a reply to an assessment question after viewing each selected image; and
determining a parameter representative of the psychophysical assessment of number-sense acuity based on each reply by the participant.

15. The system of claim 14, wherein:
the code segments, instructions and criteria for said selecting includes selecting N images from the database that have a complexity appropriate for the participant, where N is greater than or equal to two (2);
the code segments, instructions and criteria for said displaying includes displaying each of the N images to the participant for the determined display time; and
the code segments, instructions and criteria for said determining a parameter includes determining a parameter for each of the N images.

16. The system of claim 14, wherein:
the code segments, instructions and criteria for said selecting includes selecting X sets of N images from the database that have a complexity appropriate for the participant and based on the results, where X is greater than or equal to two (2);
the code segments, instructions and criteria for said displaying includes displaying each of the N images for each of the X sets to the participant for the determined display time; and
the code segments, instructions and criteria for said determining a parameter includes determining a parameter for each of the X sets of N images.

17. The system of claim 16, wherein the code segments, instructions and criteria for said selecting further includes selecting each next set (successor set) of N images after determining a complexity for the images based on the determined parameter(s) of the set of images previously displayed.

18. The system of claim 17, wherein the code segments, instructions and criteria for said displaying further includes determining another display time based on the determined parameter(s) of the set of images previously displayed before displaying for each successor set of N images and displaying the N images of a given successor set of N images at the determined display times.

19. The system of claim 16, wherein the code segments, instructions and criteria for said displaying further includes determining a successor display time based on the determined parameter(s) of the set of images previously displayed before displaying each successor set of N images and displaying the N images of a given successor set of N images at the determined successor display time.

20. The system of claim 14, further comprising the step(s) of:
inputting at least age of the participant as the participant related information.

21. A computer readable medium on which is stored an applications program for execution on a computer, wherein said applications program includes code segments, instructions and criteria for carrying out the method of claim 4.
